(19) United States
(12) Patent Application Publication
(10) Pub. No.: US 2019/0005399 A1
(43) Pub. Date: Jan. 3, 2019

(54) LEARNING DEVICE, GENERATION DEVICE, LEARNING METHOD, GENERATION METHOD, AND NON-TRANSITORY COMPUTER READABLE STORAGE MEDIUM

(71) Applicant: YAHOO JAPAN CORPORATION, Tokyo (JP)

(72) Inventors: Masaki NOGUCHI, Tokyo (JP); Ryo NAKAI, Tokyo (JP); Hayato KOBAYASHI, Tokyo (JP); Yukihiro TAGAMI, Tokyo (JP); Kazuma MURAO, Tokyo (JP)

(73) Assignee: YAHOO JAPAN CORPORATION, Tokyo (JP)

(21) Appl. No.: 15/996,968

(22) Filed: Jun. 4, 2018

(30) Foreign Application Priority Data
Jun. 28, 2017 (JP) 2017-126710

(51) Int. Cl. G06N 5/04; G06N 3/04; G06N 3/08; G06K 9/62; G06N 99/00

(52) U.S. Cl. CPC G06N 5/046; G06N 3/0454; G06N 99/005; G06K 9/6267; G06N 3/084

(57) ABSTRACT

According to one aspect of an embodiment a learning device includes an acquisition unit that acquires a plurality of pieces of input information of different classifications. The learning device includes a learning unit that learns a model as a model when the pieces of input information are inputted, outputs a plurality of pieces of output information corresponding to the respective pieces of input information. The model includes a plurality of encoding parts that generate pieces of characteristic information indicating characteristics of the pieces of input information from the pieces of input information. The model includes a synthesizing part that generates synthesized information obtained by synthesizing the pieces of characteristic information generated by the encoding parts. The model includes a plurality of decoding parts that generate pieces of output information of different classifications from the synthesized information generated by the synthesizing part.

### CROSS-REFERENCE TO RELATED APPLICATIONS

The present application claims priority to and incorporates by reference the entire contents of Japanese Patent Application No. 2017-126710 filed in Japan on Jun. 28, 2017.

### BACKGROUND OF THE INVENTION

### 1. Field of the Invention

The present invention relates to a learning device, a generation device, a learning method, a generation method, and a non-transitory computer readable storage medium.

### 2. Description of the Related Art

In the related art, there is known a technique of causing a group of a plurality of pieces of data of different classifications to be learning data, causing a model to learn relevance included in the learning data, and executing various pieces of processing using a learning result. As an example of such a technique, there is known a technique of causing a group of language data and non-language data to be learning data, causing the model to learn relevance included in the learning data, and estimating language data corresponding to non-language data using the model after learning.

Japanese Laid-open Patent Publication No. 2016-004550

However, in the learning technique described above, the relevance included in the learning data is hardly learned in some cases.

For example, in a case of causing the model to learn a characteristic of the learning data with high accuracy, a relatively large amount of learning data is required. However, it takes much time to prepare a group of pieces of data including relevance to be learned, so that a sufficient number of pieces of learning data cannot be prepared in some cases.

### SUMMARY OF THE INVENTION

It is an object of the present invention to at least partially solve the problems in the conventional technology.

According to one aspect of an embodiment a learning device includes an acquisition unit that acquires a plurality of pieces of input information of different classifications. The learning device includes a learning unit that learns a model as a model when the pieces of input information are inputted, outputs a plurality of pieces of output information corresponding to the respective pieces of input information. The model includes a plurality of encoding parts that generate pieces of characteristic information indicating characteristics of the pieces of input information from the pieces of input information. The model includes a synthesizing part that generates synthesized information obtained by synthesizing the pieces of characteristic information generated by the encoding parts. The model includes a plurality of decoding parts that generate pieces of output information of different classifications from the synthesized information generated by the synthesizing part.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of processing executed by an information providing device according to an embodiment;

FIG. 2 is a diagram illustrating a configuration example of the information providing device according to the embodiment;

FIG. 3 is a diagram illustrating an example of information registered in a learning data database according to the embodiment;

FIG. 4 is a diagram illustrating an example of information registered in a model database according to the embodiment;

FIG. 5 is a diagram illustrating an example of a structure of a processing model to be learned by the information providing device according to the embodiment;

FIG. 6 is a flowchart illustrating an example of a learning processing procedure executed by the information providing device according to the embodiment;

FIG. 7 is a flowchart illustrating an example of a generation processing procedure executed by the information providing device according to the embodiment; and

FIG. 8 is a diagram illustrating an example of a hardware configuration.

### DETAILED DESCRIPTION OF THE PREFERRED EMBODIMENTS

The following describes a mode for implementing a learning device, a generation device, a learning method, a generation method, and a non-transitory computer readable storage medium according to the present invention (hereinafter, referred to as an “embodiment”) in detail with reference to the drawings. The embodiment does not intend to limit the learning device, the generation device, the learning method, the generation method, and the non-transitory computer readable storage medium according to the present invention. In the following embodiment, the same part is denoted by the same reference numeral, and redundant description will be omitted.

### Embodiment

### 1-1. Example of Information Providing Device

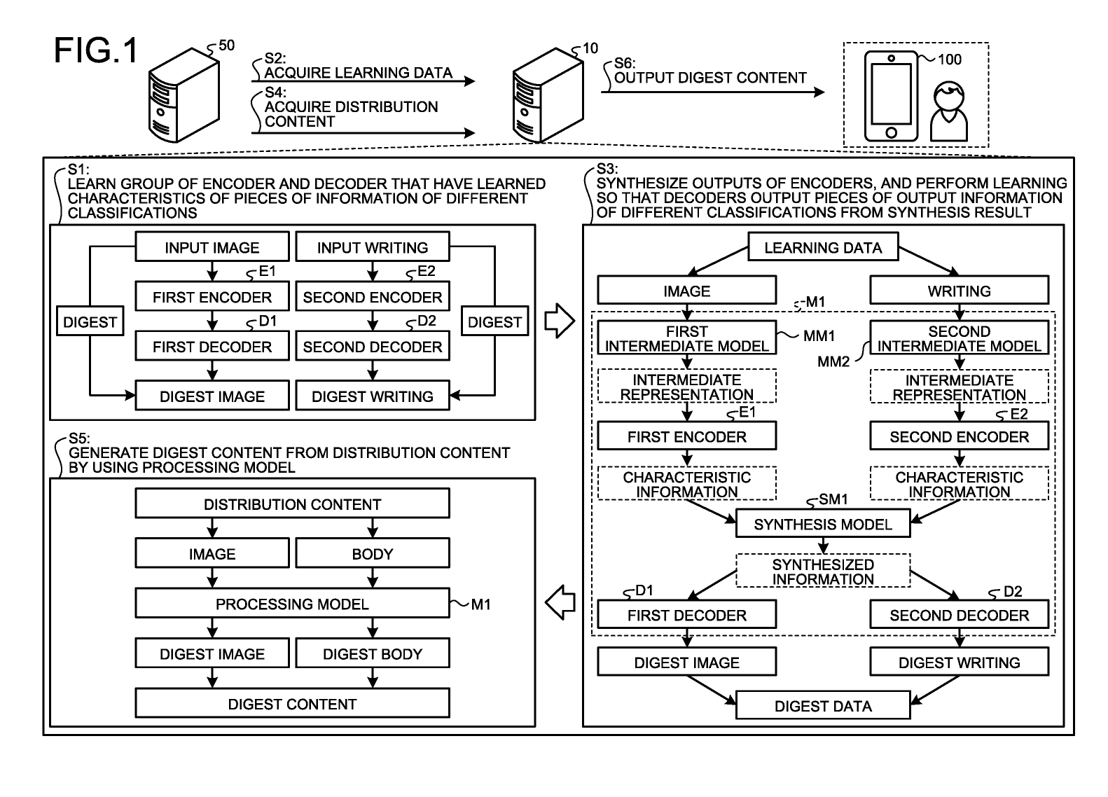

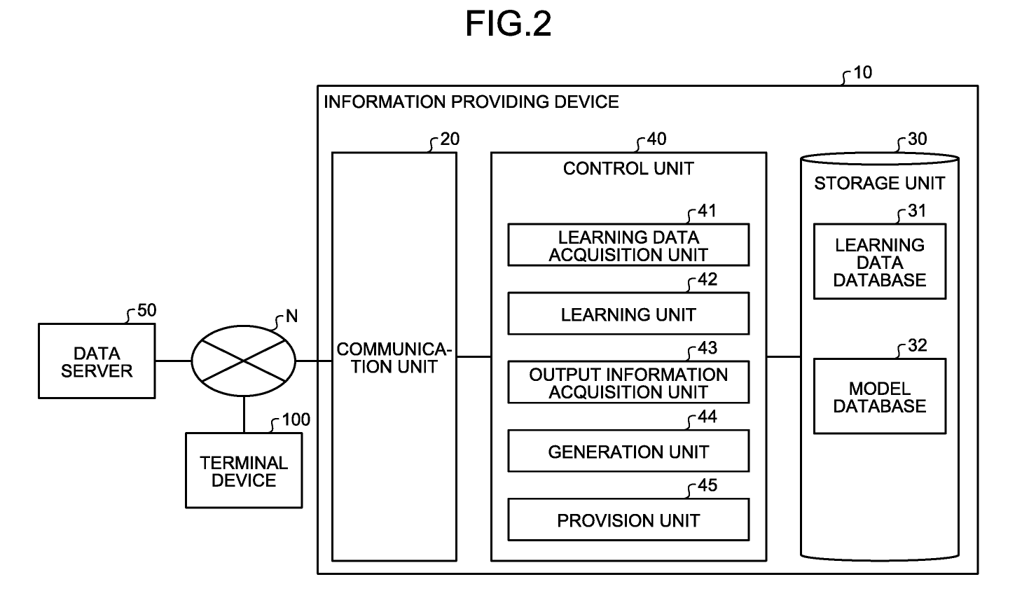

First, with reference to FIG. 1, the following describes an example of learning processing and generation processing executed by an information providing device as an example of a generation device and a learning device. FIG. 1 is a diagram illustrating an example of processing executed by the information providing device according to an embodiment. In FIG. 1, an information providing device 10 can communicate with a data server 50 and a terminal device 100 that are used by a predetermined client via a predetermined network N such as the Internet (for example, refer to FIG. 2).

The information providing device 10 is an information processing device that executes learning processing described later, and implemented by a server device or a cloud system, for example. The data server 50 is an information processing device that manages learning data used by the information providing device 10 when executing the learning processing described later, and distribution content output by the information providing device 10 when executing the generation processing described later. For example, the data server 50 is implemented by a server device or a cloud system.

For example, the data server 50 executes a distribution service for distributing news and various pieces of content contributed by a user to the terminal device 100. Such a distribution service is, for example, implemented by a distribution site of various news and a social networking service (SNS).

The terminal device 100 is a smart device such as a smartphone and a tablet, and is a portable terminal device that can communicate with an optional server device via a wireless communication network such as 3rd Generation (3G) and Long Term Evolution (LTE). The terminal device 100 is not limited to the smart device, and may be an information processing device such as a desktop personal computer (PC) and a notebook PC.

### 1-2. Regarding Distribution of Digest

When there are a plurality of pieces of distribution content as distribution targets, the data server 50 does not distribute all pieces of distribution content but distributes a piece of digest content as a digest of each piece of distribution content to the terminal device 100, and may distribute a piece of distribution content corresponding to a piece of digest content selected by the user from among the pieces of distributed digest content. However, it takes much effort to manually generate digest content for each piece of distribution content.

There may be provided a technique of automatically generating digest content from the distribution content using a model that has learned characteristics of various pieces of information. For example, the distribution content distributed by the data server 50 may include pieces of information of different classifications, that is, an image such as a photograph, text as a caption, text as a body, and the like. In such a case, there may be provided a method of individually generating a model that has learned a characteristic of each piece of information for each classification of the pieces of information included in the distribution content, and generating a digest of information from each piece of information included in the distribution content using a plurality of generated models.

For example, a digest server that generates a digest using a model different for each piece of information acquires, as learning data, an image included in the distribution content and a digest image (that is, a thumbnail) that should be included in the digest content as a digest of the distribution content. The digest server learns a model to generate a digest image from the image. Such learning is presented by a neural network and the like such as a deep neural network (DNN) in which a plurality of nodes are connected in multiple stages. Similarly, the digest server learns the model to generate a digest caption, a digest body, and the like to be included in the digest content from a caption and a body included in the distribution content. The digest server generates a digest image, a digest caption, and a digest body from an image, a caption, a body, and the like included in new distribution content by using each model that has been learned, and generates digest content by using the generated digest image, digest caption, and digest body.

However, in the processing described above, appropriate digest content cannot be generated in some cases. For example, the digest server described above generates the digest by using a model different for each piece of information included in the distribution content, so that pieces of content of the digest generated by respective models do not match each other in some cases. More specifically, for example, in a case in which there is distribution content including an image obtained by photographing a plurality of persons and a body related to any one of the photographed persons, even when a model that generates a digest body from the body creates an appropriate digest, a model that generates a digest image from the image may extract, as the digest image, a range in which a person different from the person related to the body is photographed.

There may be provided a method of directly generating digest content from a plurality of pieces of information included in the distribution content. For example, the digest server generates digest content from the distribution content using a model that has been learned to generate the digest content from the distribution content. However, in such a method, time required for learning the model and a calculation resource are increased.

### 1-3. Regarding Learning Processing

Thus, the information providing device 10 learns a processing model for generating the digest content from the distribution content by executing the learning processing described below. First, the information providing device 10 acquires pieces of information of different classifications as data used for learning the processing model, that is, learning data. The information providing device 10 generates a processing model including a plurality of encoding devices (encoding parts) that generate pieces of characteristic information indicating characteristics of pieces of input information from the pieces of input information, a synthesizing device (synthesizing part) that generates synthesized information obtained by synthesizing the pieces of characteristic information generated by the encoding devices, and a plurality of decoding devices (decoding part) that generate pieces of output information of different classifications from the synthesized information generated by the synthesizing device. The information providing device 10 learns the processing model to output, when a plurality of pieces of input information are input, a plurality of pieces of output information corresponding to the respective pieces of input information.

### 1-3-1. Regarding Generation of Partial Model

The following describes an example of the learning processing executed by the information providing device 10. First, the information providing device 10 prepares a partial model as a model for generating a digest of information for each classification of the information included in the distribution content as a generation target of a digest. For example, in a case in which the distribution content includes an image and a body, the information providing device 10 prepares a first partial model for generating a digest of the image and a second partial model for generating a digest of the body.

Such a partial model for generating the digest is implemented, for example, by a group of an encoding device (hereinafter, referred to as an “encoder” in some cases) that extracts a characteristic of the input information by compressing a dimensional quantity of the input information, and a decoding device (hereinafter, referred to as a “decoder” in some cases) that increases a dimensional quantity of the characteristic extracted by the encoder and outputs a digest of information having dimensionality less than that of the information input to the encoder, that is, the input information. As the encoder and the decoder, not only a neural network that simply varies dimensionality of an amount of input information but also various neural networks can be employed such as a convolution neural network (CNN), a recurrent neural network (RNN), and a long short-term memory (LSTM).

The information providing device 10 causes the prepared partial model to learn the characteristic of the information. For example, the information providing device 10 acquires, as learning data of the first partial model corresponding to the image, a group of an image and a digest image obtained by extracting an optimum range as a thumbnail from the image. The learning data of the first partial model is not necessarily the learning data related to the image included in the distribution content, and implemented by a group of a typical image and a digest image as a principal part of the image.

The information providing device 10 learns the first partial model to output a pixel value of each pixel included in the digest image of the learning data when the pixel value of each pixel included in the image of the learning data is input. For example, the information providing device 10 corrects a value of weight (that is, a connection coefficient) that is considered when the value is transmitted between respective nodes by using a method such as backpropagation so that the pixel value output by the first partial model comes close to the pixel value of each pixel included in the digest image of the learning data, and causes the first partial model to learn the characteristic of the typical image.

Similarly, the information providing device 10 acquires a group of writing and digest writing as a digest of the writing as learning data of the second partial model corresponding to the body. The learning data of the second partial model is not necessarily the learning data related to the body included in the distribution content, and implemented by a group of typical writing and digest writing as a digest of the typical writing.

The information providing device 10 learns the second partial model to output a vector of each word included in the digest writing of the learning data when information obtained by vectorizing each word included in the writing of the learning data is input. For example, the information providing device 10 corrects a value of weight (that is, a connection coefficient) that is considered when the value is transmitted between respective nodes by using a method such as backpropagation so that the vector output by the second partial model comes close to the vector of each word included in the digest writing of the learning data, and causes the second partial model to learn the characteristic of the typical writing.

### 1-3-2. Regarding Generation of Processing Model

Subsequently, the information providing device 10 extracts an encoder included in the first partial model as a first encoder, and a decoder included in the first partial model as a first decoder. The information providing device 10 extracts an encoder included in the second partial model as a second encoder, and a decoder included in the second partial model as a second decoder.

The information providing device 10 couples, to the first encoder and the second encoder, a synthesis model that generates synthesized information obtained by synthesizing an output of the first encoder, that is, characteristic information as information indicating a characteristic of an input image, and an output of the second encoder, that is, characteristic information as information indicating a characteristic of an input body.

For example, the information providing device 10 generates a synthesis model that outputs, as synthesized information, a linear combination of the characteristic information output by the first encoder and the characteristic information output by the second encoder. Such a synthesis model can be, for example, implemented by an intermediate layer and a model receiving characteristic information output by the first encoder and the second encoder having a multidimensional quantity (for example, a vector) indicating characteristics of the image and the body, and outputting information obtained by linearly combining the received characteristic information. As described later, the synthesis model may generate synthesized information obtained by applying predetermined weight to each piece of characteristic information.

The information providing device 10 couples the first decoder and the second decoder so that the synthesized information output by the synthesis model is input to the first decoder and the second decoder. For example, the information providing device 10 couples the first decoder to the synthesis model to convolute the synthesized information output by the synthesis model to have dimensionality corresponding to an input layer of the first decoder, and input the convoluted synthesized information to the first decoder. The information providing device 10 couples the second decoder to the synthesis model to convolute the synthesized information output by the synthesis model to have dimensionality corresponding to the input layer of the second decoder, and input the convoluted synthesized information to the second decoder.

In this way, the information providing device 10 generates a processing model including a plurality of encoders that have learned characteristics of pieces of information of different classifications, and a plurality of decoders that have learned characteristics of pieces of information of the same classification as that of different encoders. For example, the information providing device 10 generates a processing model including the first encoder and the first decoder that have learned the characteristic of the image, and the second encoder and the second decoder that have learned the characteristic of the body. The information providing device 10 generates a processing model including a plurality of decoders that generate pieces of information of different classifications from the synthesized information, and output pieces of information of the same classification as that of pieces of information input to different encoders. For example, the information providing device 10 generates a processing model including a first decoder that outputs pieces of information of the same classification as that of the information input to the first encoder, that is, a digest image, and the second decoder that outputs pieces of information of the same classification as that of the information input to the second encoder, that is, a digest body.

As a result of such processing, the information providing device 10 can obtain a processing model having a configuration of individually extracting the characteristic of the image and the characteristic of the body, synthesizing the extracted characteristics, and generating the digest image and the digest body from the synthesized information obtained by synthesizing the characteristics. The information providing device 10 learns the processing model by using, as the learning data, a group of the distribution content and the digest content corresponding to the distribution content generated in advance.

For example, the information providing device 10 learns the processing model so that, when the image of the distribution content is input to the first encoder included in the processing model and the body of the distribution content is input to the second encoder, the digest image and the digest writing output by the processing model matches the digest image and the digest writing included in the digest content. For example, the information providing device 10 may individually correct the connection coefficient of the first encoder, the second encoder, the first decoder, and the second decoder included in the processing model, or may correct the connection coefficient included in the synthesis model. The information providing device 10 may only correct the connection coefficient of the first decoder and the second decoder, for example. That is, the information providing device 10 may perform optional learning so long as learning of the processing model is performed to output pieces of information having pieces of content associated with each other from a plurality of pieces of information of different classifications included in predetermined content.

As a result of such processing, the information providing device 10 can generate the processing model that individually extracts characteristics of pieces of information included in the distribution content for each classification of the information, integrates the extracted characteristics, and individually generates the digest of each piece of information included in the distribution content based on the integrated characteristics. That is, different from the conventional CNN in which when pieces of information of different classifications are input, the pieces of information of the different classifications are convoluted, the information providing device 10 generates the processing model that individually extracts the characteristic information for each classification of the information, generates the synthesized information obtained by synthesizing extracted pieces of characteristic information, and generates information to be individually output again for each classification of the information from the generated synthesized information.

In other words, the information providing device 10 extracts the characteristic information using the encoders that are not connected to each other and have learned the characteristics of pieces of information of different classifications, and generates a plurality of pieces of information of different classifications from the synthesized information obtained by synthesizing pieces of characteristic information extracted by the respective encoders using decoders that are not connected to each other and have learned the characteristics of pieces of information of different classifications. As a result, the information providing device 10 can facilitate learning of relevance included in the learning data.

For example, the information providing device 10 generates the processing model using a partial model that has learned a characteristic of typical information for each classification of the information such as an image and a body. As a result, the processing model can be obtained in a state in which the characteristics of the pieces of information included in the distribution content are pre-trained. As a result, the information providing device 10 can reduce the number of pieces of learning data required for ensuring predetermined accuracy, that is, the number of groups of the distribution content and the digest content including pieces of information of a plurality of classifications, and can reduce time required for learning and a calculation resource.

In the processing model having the structure described above, portions that generate the characteristic information from the pieces of input information are not connected to each other, and portions that generate pieces of output information from the synthesized information are also not connected to each other. As a result, the information providing device 10 reduces the number of connection coefficients that should be considered in learning, so that a resource required for learning can be reduced.

In the processing model described above, in a case in which accuracy of only one of a plurality of pieces of output information is lower than that of the other pieces of output information, it is estimated that a decoder that has generated the piece of output information having low accuracy from the synthesized information or an encoder that has generated the characteristic information from the input information corresponding to the output information (that is, a group of the encoder and the decoder corresponding to the classification of the output information having low accuracy) has a cause of lowering the accuracy. In this way, the processing model having the structure described above can easily estimate a portion that should be corrected in learning, so that time required for learning and a calculation resource can be reduced.

The information providing device 10 does not individually use the characteristics of the pieces of information, and uses the information obtained by synthesizing the characteristics of the pieces of information, that is, the information obtained by integrating the characteristics of the pieces of information to individually generate the digest of each piece of information. Thus, the information providing device 10 can adjust content of digests to be generated such as a digest image and a digest body.

### 1-4. Regarding Generation Processing

Next, the following describes an example of generation processing for generating digest content using the processing model that has been learned through the learning processing described above. First, the information providing device 10 acquires the distribution content as a generation target of the digest content. The information providing device 10 inputs the image and the body included in the digest content to the processing model, and acquires the digest image and the digest body generated by the processing model. Thereafter, the information providing device 10 generates the digest content using the digest image and the digest body, and distributes the generated digest content to the terminal device 100.

That is, the information providing device 10 acquires a plurality of pieces of output information corresponding to a plurality of pieces of input information included in the distribution content using a plurality of encoders that generate pieces of characteristic information indicating the characteristics of the pieces of input information from the pieces of input information of different classifications, the synthesis model that generates synthesized information obtained by synthesizing the pieces of characteristic information generated by the encoders, and a plurality of decoders that generate the pieces of output information corresponding to the pieces of input information of different classifications from the synthesized information generated by the synthesis model. The information providing device 10 then generates digest content corresponding to predetermined content from the acquired pieces of output information.

For example, the information providing device 10 extracts a plurality of pieces of information of different classifications included in the distribution content. More specifically, for example, the information providing device 10 extracts an image and a body included in the distribution content. The information providing device 10 inputs a pixel value of each pixel included in the extracted image to a node corresponding to the input layer of the first encoder in the processing model, and inputs a vector of each word included in the extracted body to a node corresponding to an input device of the second encoder in the processing model.

As a result, the information providing device 10 individually extracts the characteristic of the image and the characteristic of the body through the processing executed by the processing model, generates the synthesized information obtained by synthesizing the extracted characteristics, and can obtain a digest image and digest writing that are individually generated from the generated synthesized information. The information providing device 10 then generates the digest content using the digest image and the digest writing. As a result, the information providing device 10 can appropriately generate the digest content as a digest of the distribution content.

### 1-5. Regarding Preprocessing

The information providing device 10 may input intermediate representation indicating characteristics of various pieces of information instead of directly inputting the information of the distribution content to the first encoder and the second encoder included in the processing model. For example, the information providing device 10 may use a plurality of intermediate models that have a structure corresponding to the classification of the input information and generate the intermediate representation indicating the characteristic of the input information, and a plurality of encoders that generate the characteristic information from the intermediate representation generated by each intermediate model.

For example, the information providing device 10 acquires a first intermediate model that has been learned to generate the intermediate representation including information indicating the characteristic of the image and required for generating the digest of the image from various images. The information providing device 10 acquires a second intermediate model that has been learned to generate the intermediate representation including information indicating the characteristic of the writing and required for generating the digest of the writing from various pieces of writing.

The intermediate model that generates the intermediate representation indicating the characteristic of the information can be implemented by various neural networks, but a structure of a model that can extract the characteristic of the information with high accuracy is different depending on the classification of the information. For example, the characteristic of the image is considered to be based on not only a single pixel but also adjacent surrounding pixels. Thus, as a model for extracting the characteristic of the image, a neural network that convolutes the information, that is, a CNN is preferably used. On the other hand, the characteristic of the writing such as a body is considered to be based on not only a single word but also another word before or after the word, a word group following the word, and the like. Thus, as a model for extracting the characteristic of the body, a recursive neural network such as an RNN and an LSTM is preferably used.

The information providing device 10 acquires the intermediate model having a structure different for each classification of the information for generating the digest, that is, information as a processing target. For example, the information providing device 10 acquires the first intermediate model including the structure of the CNN as the intermediate model for generating the intermediate representation of the image. The information providing device 10 acquires the second intermediate model including the structure of the RNN as the intermediate model for generating the intermediate representation of the body. The information providing device 10 inputs the image included in the distribution content to the first intermediate model, and inputs the intermediate representation output by the first intermediate model to the first encoder included in the processing model. The information providing device 10 inputs the writing included in the distribution content to the second intermediate model, and inputs the intermediate representation output by the second intermediate model to the second encoder included in the processing model. As a result of such processing, the information providing device 10 can generate the digest of each piece of information with higher accuracy.

The information providing device 10 may learn the processing model including the intermediate model, and may learn and use the intermediate model independently of the processing model. For example, in a case in which the processing model does not include the intermediate model, the information providing device 10 may generate the intermediate representation using the intermediate model that has been learned independently of the processing model, and may input the generated intermediate representation to the processing model. In a case in which the processing model includes the intermediate model, the information providing device 10 may input various pieces of information included in the distribution content to the processing model as it is.

### 1-6. Regarding Example of Processing

Next, the following describes an example of a procedure of learning processing and generation processing executed by the information providing device 10 with reference to FIG. 1. First, the information providing device 10 executes learning processing. Specifically, the information providing device 10 learns a group of the encoder and the decoder that have learned characteristics of pieces of information of different classifications (Step S1).

For example, the information providing device 10 learns a first encoder E1 and a first decoder D1 so that, when a typical image is input to the first encoder E1 as an input image and information output by the first encoder E1 is input to the first decoder D1, an image output by the first decoder D1 becomes a digest image as a digest of the input image. For example, the information providing device 10 learns a second encoder E2 and a second decoder D2 so that, when the typical writing is input to the second encoder E2 as input writing and information output by the second encoder E2 is input to the second decoder D2, writing output by the second decoder D2 becomes digest writing as a digest of the input writing. In the following description, each of the encoders such as the first encoder E1 and the second encoder E2 may be collectively referred to as an “encoder E”, and each of the decoders such as the first decoder D1 and the second decoder D2 may be collectively referred to as a “decoder D”.

Next, the information providing device 10 acquires learning data used for learning the processing model from the data server 50 (Step S2). For example, the information providing device 10 collects, as the learning data, a group of the distribution content and the digest content as a digest of the distribution content. The information providing device 10 learns the processing model so that outputs of respective encoders E are synthesized, and respective decoders D output pieces of output information of different classifications from the synthesis result (Step S3).

For example, the information providing device 10 acquires a first intermediate model MM1 for generating the intermediate representation of the image, and a second intermediate model MM2 for generating the intermediate representation of the writing. The information providing device 10 generates a processing model M1 having the following structure. For example, the information providing device 10 generates the processing model M1 having a structure in which the intermediate representation output by the first intermediate model MM1 is input to the first encoder E1 as the input information, and the intermediate representation output by the second intermediate model MM2 is input to the second encoder E2 as the input information. The information providing device 10 generates the processing model M1 having a structure in which the characteristic information generated from the intermediate representation by the first encoder E1 and the characteristic information generated from the intermediate representation by the second encoder E2 are input to a synthesis model SM1.

The information providing device 10 generates the processing model M1 having a structure in which the synthesized information synthesized from the pieces of characteristic information by the synthesis model SM1 is input to the first decoder D1 and the second decoder D2. That is, as illustrated in FIG. 1, the information providing device 10 generates the processing model M1 having a structure of individually generating the characteristic information indicating the characteristic of the image and the characteristic information indicating the characteristic of the writing, synthesizing the generated pieces of characteristic information, and individually generating the digest image and the digest writing from the synthesized information.

The information providing device 10 inputs the image included in the learning data to the first intermediate model MM1 of the processing model M1, and inputs the writing included in the learning data to the second intermediate model MM2. The information providing device 10 then learns the processing model M1 so that the digest image output by the first decoder D1 of the processing model M1 becomes the digest of the image input to the first intermediate model MM1 of the processing model M1, the digest writing output by the second decoder D2 of the processing model M1 becomes the digest of the writing input to the second intermediate model MM2 of the processing model M1, and the digest image and the digest writing represent a common event.

For example, the information providing device 10 may correct only connection coefficients of the first decoder D1 and the second decoder D2, or may correct the connection coefficients of the entire processing model M1. For example, in a case in which the digest writing output by the second decoder D2 is an appropriate digest but the digest image generated by the first decoder D1 is not an appropriate digest image, it can be considered that learning accuracy of the first intermediate model MM1, the first encoder E1, and the first decoder D1 is low. Thus, in a case in which the digest writing output by the second decoder D2 is an appropriate digest but the digest image generated by the first decoder D1 is not an appropriate digest image, the information providing device 10 may correct only the connection coefficients of the first intermediate model MM1, the first encoder E1, and the first decoder D1 among the connection coefficients included in the processing model M1.

Subsequently, the information providing device 10 executes generation processing. Specifically, the information providing device 10 acquires the distribution content as a generation target of the digest content from the data server 50 (Step S4). The information providing device 10 then generates the digest content from the distribution content using the processing model M1 (Step S5).

For example, the information providing device 10 extracts information of the classification corresponding to each encoder E included in the processing model M1 from the distribution content. More specifically, the information providing device 10 extracts the image and the body from the distribution content. The information providing device 10 then inputs the image and the body to the processing model M1, and acquires the digest image and the digest body. Thereafter, the information providing device 10 generates the digest content using the acquired digest image and digest body, and outputs the generated digest content to the terminal device 100 (Step S6).

### 1-7. Regarding Processing Target

In the above description, the information providing device 10 learns the processing model M1 for generating the digest image as a digest of the image included in the distribution content and the digest body as a digest of the body included in the distribution content. However, the embodiment is not limited thereto. For example, so long as the processing model M1 outputs information (hereinafter, referred to as “output information”) corresponding to information to be input (hereinafter, referred to as “input information”) in addition to the digest, the information providing device 10 may generate the processing model M1 for generating output information having optional relevance to the input information. The information providing device 10 may generate the output information of optional information from the input information of optional classification. That is, so long as the processing model M1 outputs, from a plurality of pieces of input information of different classifications including a common topic, a plurality of pieces of output information holding the topic, the information providing device 10 may generate the processing model M1 for executing optional processing on information of optional classification.

For example, the information providing device 10 may generate the processing model M1 for extracting a principal part of an image included in a moving image and a principal part of voice included in the moving image. The principal parts may be an image and voice included in the same reproduction position in the moving image, or an image and voice included in different reproduction positions. In a case in which an image and voice of a music video are assumed to be the input information, the information providing device 10 may generate the processing model M1 for outputting the principal part of the image included in the moving image and a digest of lyrics. That is, the information providing device 10 may generate the processing model M1 described above for optional input information and output information so long as the input information is a plurality of pieces of input information to have a common topic with the output information corresponding to each piece of input information.

The information providing device 10 may generate the processing model M1 that generates, from three or more pieces of input information, pieces of output information corresponding to the respective pieces of input information, the pieces of output information having a common topic with the pieces of input information. For example, the information providing device 10 may generate the processing model M1 that generates the output information from the pieces of input information of optional numbers of classifications so long as the processing model M1 has the encoder different for each classification of the input information, generates the synthesized information from the pieces of characteristic information output by the respective encoders E, and generates the pieces of output information corresponding to the pieces of input information from the generated synthesized information.

For example, in a case in which there are pieces of information of a plurality of classifications such as an image, a title, and a body in the distribution content, the information providing device 10 may generate the processing model M1 including a group of a plurality of independent encoders that extract the characteristic of each of the image, the title, and the body, the synthesis model that synthesizes pieces of characteristic information output by the encoders E, and a plurality of independent decoders that individually output pieces of information corresponding to the image, the title, and the body from the synthesized information. For example, the information providing device 10 does not necessarily generate the digest of all pieces of information included in the distribution content, and may generate the processing model M1 including at least the first encoder E1 that generates characteristic information indicating the characteristic of the image, the second encoder E2 that generates characteristic information indicating the characteristic of the body as text, the synthesis model SM1 that generates the synthesized information, the first decoder D1 that generates the output information corresponding to the image from the synthesized information, and the second decoder D2 that generates the output information corresponding to the body from the synthesized information.

### 1-8. Regarding Generation of Synthesized Information

The synthesis model SM1 may generate the synthesized information synthesized by using an optional synthesizing method so long as the synthesized information is generated by synthesizing the pieces of characteristic information output by the respective encoders E. For example, the synthesis model SM1 may combine the characteristic information output by the second encoder E2 with the end of the characteristic information output by the first encoder E1, and may combine the characteristic information output by the first encoder E1 with the end of the characteristic information output by the second encoder E2. The synthesis model SM1 may cause a tensor product of the characteristic information output by the first encoder E1 and the characteristic information output by the second encoder E2 to be the synthesized information.

The characteristic information output by each encoder E is not only the information generated as a single vector but also may be a plurality of vectors. For example, each encoder E may generate the characteristic information including a plurality of vectors. In such a case, the synthesis model SM1 may generate the synthesized information obtained by synthesizing a plurality of vectors output by the encoders E, and may generate the synthesized information obtained by considering different weights for each vector.

For example, in an encoder decoder model including a group of the encoder E and the decoder D, there is known a technique of improving the whole accuracy by introducing an attention mechanism that varies the characteristic information generated by the encoder E in accordance with a state on the decoder D side (an immediately preceding output). In the encoder decoder model into which the attention mechanism is introduced, the encoder E outputs the characteristic information of a set of vectors corresponding to an input word (hidden state vector), and the decoder D predicts the next word by using a weighted mean of the set of vectors. In the encoder decoder model, soft alignment can be implemented by varying the weight of the weighted mean in accordance with the state on the decoder D side.

The information providing device 10 may use the synthesis model SM1 for outputting the synthesized information obtained by considering different weights for the first decoder D1 and the second decoder D2. For example, the synthesis model SM1 inputs, to the first decoder D1, a linear combination of a value obtained by integrating the characteristic information output by the first encoder E1 with a first weight (for example, “0.8”) and a value obtained by integrating the characteristic information output by the second encoder E2 with a second weight (for example, “0.2”) as the synthesized information. On the other hand, the synthesis model SM1 inputs, to the second decoder D2, a linear combination of a value obtained by integrating the characteristic information output by the first encoder E1 with the second weight and a value obtained by integrating the characteristic information output by the second encoder E2 with the first weight as the synthesized information.

The synthesis model SM1 is, for example, implemented by a neural network having a structure as described below. For example, the synthesis model SM1 includes an intermediate layer including a first node group to which the characteristic information output by the first encoder E1 is input, and a second node group to which the characteristic information output by the second encoder E2 is input. The synthesis model SM1 includes a first connection coefficient group for applying the first weight to the information transmitted from the first node group to the first decoder D1, and a second connection coefficient group for applying the second weight to the information transmitted from the second node group to the second decoder D2. The synthesis model SM1 also includes a third connection coefficient group for applying the second weight to the information transmitted from the first node group to the second decoder D2, and a fourth connection coefficient group for applying the first weight to the information transmitted from the second node group to the second decoder D2.

As the weight to be applied in generating the synthesized information or in outputting the synthesized information, an optional value can be appropriately employed in accordance with a purpose. For example, the information providing device 10 may set the weight so that topics included in a plurality of pieces of output information output by the processing model M1 match with each other. The information providing device 10 may apply different weights to respective values transmitted from each node included in the first node group and each node included in the second node group to the first decoder D1 and the second decoder D2.

In distributing the digest content, it can be considered that the digest image attracts more attention than the digest writing with high possibility. In a case in which the processing model M1 generates the digest content, the information providing device 10 may set the first weight to be a value larger than the second weight. That is, the information providing device 10 may vary a weight value in accordance with an information distribution mode related to the output information of the processing model M1.

The information providing device 10 may employ different weights for the synthesized information transmitted to the first decoder D1 and the synthesized information transmitted to the second decoder D2. For example, the information providing device 10 may transmit, to the first decoder D1, the synthesized information employing the first weight for the characteristic information of the first encoder E1 and employing the second weight for the characteristic information of the second encoder E2, and may transmit, to the second decoder D2, the synthesized information employing a third weight for the characteristic information of the first encoder E1 and employing a fourth weight for the characteristic information of the second encoder E2.

The information providing device 10 may generate the synthesized information from the characteristic information in a synthesizing mode corresponding to an output mode of content generated from the output information, that is, content corresponding to the content input to the processing model M1 (hereinafter, referred to as “corresponding content”). For example, in a case in which a user who views the digest content has an attribute of attaching importance to the image, the information providing device 10 may cause the first weight to be a value larger than the second weight.

In a case in which a region in which the digest image is displayed is larger than a region in which the digest body is displayed in the digest content, the information providing device 10 may cause the first weight and the third weight to be a value larger than the second weight and the fourth weight. Additionally, the information providing device 10 can employ an optional weight in accordance with various demographic attributes and psychographic attributes, a purchase history, a retrieval history, a browsing history of various pieces of content of the user that is a distribution destination of target content, a history of digest content selected by the user, and the like.

The information providing device 10 may learn various weights employed by the synthesis model SM1. For example, the information providing device 10 may correct the weight employed by the synthesis model SM1, that is, the connection coefficient of the synthesis model SM1 in correcting the connection coefficient of the first decoder D1 or the second decoder D2 so that the processing model M1 appropriately outputs the digest image and the digest writing. In this case, the information providing device 10 may correct the connection coefficient of the synthesis model SM1 in accordance with the attribute of the user who has selected the digest data, and may correct the connection coefficient of the synthesis model SM1 in accordance with the attribute of the user who has not selected the digest data.

The information providing device 10 may cause a predetermined model (hereinafter, referred to as a “weight model”) to learn relevance between the attribute of the user and a weight employed by the synthesis model SM1. In such a case, in generating the digest content of the distribution content, the information providing device 10 calculates a weight value employed by the synthesis model SM1 from the weight model in accordance with the attribute of the user who desires to view the distribution content. The information providing device 10 may generate the digest data after setting the calculated weight value to the synthesis model SM1 included in the processing model M1.

In this way, the information providing device 10 may generate the synthesized information while attaching more importance to the information included in the image. In this way, the information providing device 10 may generate the synthesized information obtained by synthesizing the pieces of characteristic information in the synthesizing mode corresponding to the attribute of the user that is the output destination of the corresponding content, and may use the synthesis model SM1 for generating the synthesized information corresponding to the output mode of the corresponding content from the information obtained by linearly combining the pieces of characteristic information.

### 1-9. Others

The information providing device 10 may learn the processing model M1 to generate a digest image having an optional shape. For example, the information providing device 10 may learn the processing model M1 to generate the digest image having an optional shape such as a quadrangle, a triangle, and a circular shape in accordance with the attribute of the user, the attribute of the image, content of the body, and the like. The information providing device 10 may learn the processing model M1 so that, when a plurality of images are included in the distribution content, ranges having high relevance with a region or a body attracting much attention in the respective images are extracted, and an image obtained by synthesizing the extracted ranges like a patchwork is generated as the digest image.

For example, the information providing device 10 may learn the processing model M1 so that, when the content of the body is related to a person, a square range in which a face of the person mentioned in the body is photographed is extracted. The information providing device 10 may learn the processing model M1 so that, when the content of the body is related to a vehicle and the image is a photograph of a vehicle, a rectangular range in which the vehicle is photographed is extracted.

The information providing device 10 may vary the configuration of the encoder or the decoder in accordance with classification of the input information as a processing target. For example, the information providing device 10 may configure the first encoder E1 and the first decoder D1 with a CNN, and may configure the second encoder E2 and the second decoder D2 with an RNN.

### 2. Configuration of Information Providing Device

The following describes an example of a functional configuration of the information providing device 10 that implements the learning processing described above. FIG. 2 is a diagram illustrating a configuration example of the information providing device according to the embodiment. As illustrated in FIG. 2, the information providing device 10 includes a communication unit 20, a storage unit 30, and a control unit 40.

The communication unit 20 is implemented by a network interface card (NIC), for example. The communication unit 20 is connected to the network N in a wired or wireless manner, and transmits/receives information to/from the terminal device 100 and the data server 50.

The storage unit 30 is, for example, implemented by a semiconductor memory element such as a random access memory (RAM) and a flash memory, or a storage device such as a hard disk and an optical disc. The storage unit 30 stores a learning data database 31 and a model database 32.

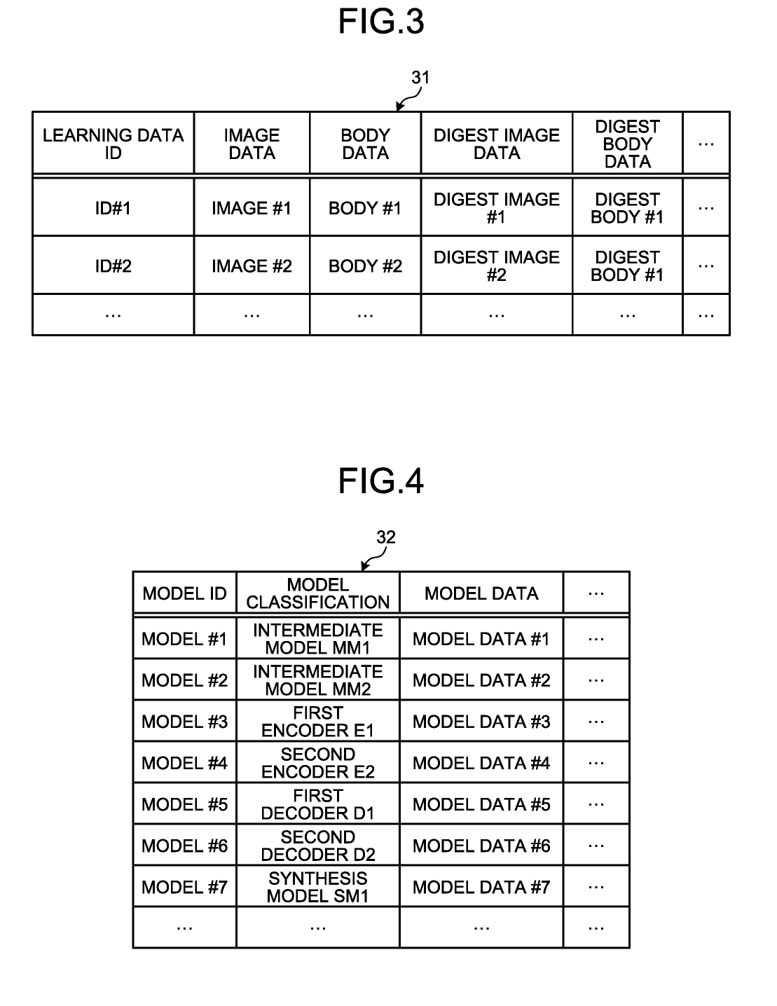

The learning data is registered in the learning data database 31. For example, FIG. 3 is a diagram illustrating an example of the information registered in the learning data database according to the embodiment. As illustrated in FIG. 3, information including items such as “learning data ID (identifier)”, “image data”, “body data”, “digest image data”, and “digest body data” is registered in the learning data database 31.

Among the pieces of information illustrated in FIG. 3, the “image data” and the “body data” correspond to the “learning data” illustrated in FIG. 1, and the “digest image data” and the “digest body data” correspond to the “digest data” illustrated in FIG. 1. In addition to the information illustrated in FIG. 3, various pieces of information related to the user who has viewed the learning data and the digest data may be registered in the learning data database 31. In the example illustrated in FIG. 3, described are pieces of conceptual information such as “image #1”, “body #1”, “digest image #1”, and “digest body #1”. Actually, various pieces of image data and text data are registered.

The “learning data ID” is an identifier for identifying the learning data. The “image data” is data related to the image included in the learning data. The “body data” is data of the text included in the learning data. The “digest image data” is data of an image displayed as the digest image. The “digest body data” is data of text as the digest body.

For example, in the example illustrated in FIG. 3, pieces of information such as the learning data ID “ID #1”, the image data “image #1”, the body data “body #1”, the digest image data “digest image #1”, and the digest body data “digest body #1” are registered while being associated with each other. Such information indicates, for example, that the learning data indicated by the learning data ID “ID #1” includes the image indicated by the image data “image #1” and the body indicated by the body data “body #1”, and the digest data as the digest of the learning data includes the digest image indicated by the digest image data “digest image #1” and the digest body indicated by the digest body data “digest body #1”.

Returning to FIG. 2, the description will be continued. In the model database 32, data of various models included in the processing model M1 is registered as the processing model M1. For example, FIG. 4 is a diagram illustrating an example of the information registered in the model database according to the embodiment. In the example illustrated in FIG. 4, in the model database 32, information such as “model ID”, “model classification”, and “model data” is registered.

The “model ID” is information for identifying each model. The “model classification” is information indicating whether a model indicated by the associated “model ID” is the intermediate model, the encoder, the decoder, or the synthesis model. The “model data” is data of a model indicated by the associated “model ID”, and is information including a node in each layer, a function employed by each node, a connection relation of nodes, and the connection coefficient set for connection between the nodes, for example.

For example, in the example illustrated in FIG. 4, pieces of information such as the model ID “model #1”, the model classification “intermediate model MM1”, and the model data “model data #1” are registered while being associated with each other. Such information indicates, for example, that the classification of the model indicated by the model ID “model #1” is the “intermediate model MM1”, and data of the model is “model data #1”. In the example illustrated in FIG. 4, described are pieces of conceptual information such as the “model #1”, the “intermediate model MM1”, and the “model data #1”. Actually, registered are a character string for identifying the model, a character string indicating the classification of the model, and a character string, numerical value, and the like indicating a structure of the model and a connection coefficient.

In the model database 32, information of the first intermediate model MM1, the second intermediate model MM2, the first encoder E1, the second encoder E2, the synthesis model SM1, the first decoder D1, and the second decoder D2 is registered as the processing model M1. The processing model M1 is a model that includes: an input layer to which pieces of information of different classifications are input; an output layer; a first element belonging to any layer from the input layer to the output layer other than the output layer; and a second element the value of which is calculated based on the first element and the weight of the first element, and causes a computer to function to output values indicating a plurality of pieces of output information of different classifications corresponding to the respective pieces of input information by performing arithmetic operation based on the first element and the weight of the first element (that is, the connection coefficient) on the information input to the input layer using each element belonging to each layer other than the output layer as the first element.

In a case in which the processing model M1 is implemented by a neural network including one or a plurality of intermediate layers such as a DNN, the first element included in the processing model M1 can be assumed to be any node included in the input layer or the intermediate layer, the second element corresponds to a node to which a value is transmitted from a node corresponding to the first element, that is, a node of the next stage, and the weight of the first element is a weight considered for a value transmitted from the node corresponding to the first element to the node corresponding to the second element, that is, the connection coefficient.

The information providing device 10 generates the output information using the processing model M1. More specifically, the processing model M1 is a model for causing the information providing device 10 to execute, when pieces of input information of different classifications are input, a series of processing of individually generating the characteristic information for each piece of input information, generating the synthesized information obtained by synthesizing generated pieces of characteristic information, and individually generating pieces of output information of different classifications from the generated synthesized information.

Returning to FIG. 2, the description will be continued. The control unit 40 is a controller, and is implemented when various programs stored in a storage device inside the information providing device 10 are executed by a processor such as a central processing unit (CPU) and a micro processing unit (MPU) using a RAM and the like as a working area, for example. The control unit 40 is a controller, and may be implemented by an integrated circuit such as an application specific integrated circuit (ASIC) and a field programmable gate array (FPGA), for example.

Through information processing in accordance with the processing model M1 stored in the storage unit 30, the control unit 40 performs arithmetic operation on a plurality of pieces of input information input to the input layer of the processing model M1 based on a coefficient included in the processing model M1 (that is, a coefficient corresponding to each of various characteristics learned by the processing model M1), and outputs pieces of output information of different classifications corresponding to pieces of input information of different classifications from the output layer of the processing model M1.

In the example described above, exemplified is a case in which the processing model M1 is a model for outputting, when a plurality of pieces of input information of different classifications are input, pieces of output information corresponding to the respective pieces of input information such as a digest of each piece of input information. However, the processing model M1 according to the embodiment may be another model that is generated based on a result obtained by repeating input/output of data for the processing model M1. For example, the processing model M1 may be another model that outputs output information when a certain piece of input information is input, and that has been learned to output the same output information as output information generated from the input information by the processing model M1.

In a case in which the information providing device 10 performs learning processing using generative adversarial networks (GAN), a model 123 may be a model configuring part of the GAN.

As illustrated in FIG. 2, the control unit 40 includes a learning data acquisition unit 41, a learning unit 42, an output information acquisition unit 43, a generation unit 44, and a provision unit 45. The learning data acquisition unit 41 acquires a group of pieces of information of different classifications as the learning data. For example, the learning data acquisition unit 41 acquires, from the data server 50, a group of the image and the body included in the distribution content as the learning data, and acquires the digest image as a digest of the image included in the distribution content and the body digest as a digest of the body as the digest data. The learning data acquisition unit 41 then associates the acquired pieces of data with each other to be registered in the learning data database 31.

The learning unit 42 learns the processing model M1, and stores the processing model M1 after learning in the model database 32. More specifically, the learning unit 42 sets the connection coefficient of each model included in the processing model M1 so that the processing model M1 outputs the digest data when the learning data is input to the processing model M1. That is, the learning unit 42 learns the processing model M1 so that, when pieces of input information of different classifications are input, the processing model M1 outputs pieces of output information of different classifications corresponding to the respective pieces of input information.

For example, the learning unit 42 causes the output information to be output by inputting the input information to the node of the input layer included in the processing model M1, the node corresponding to the input layer of the encoder E that has learned a characteristic corresponding to the input information, and causing the data to be propagated to the output layer of the processing model M1 through the intermediate layers. The learning unit 42 corrects the connection coefficient of the processing model M1 based on a difference between the output information that is actually output by the processing model M1 and the output information that is expected to be output from the input information. For example, the learning unit 42 may correct the connection coefficient using a method such as backpropagation. In this case, for example, the learning unit 42 may correct the connection coefficient in accordance with a comparison result of the topics included in the pieces of output information.

The learning unit 42 may learn the processing model M1 using any learning algorithm. For example, the learning unit 42 may learn each model included in the processing model M1 using a learning algorithm such as a neural network, a support vector machine, clustering, and reinforcement learning.

The learning unit 42 learns the processing model M1 including the encoders E1 and E2 that generate pieces of characteristic information indicating the characteristics of the pieces of input information from the pieces of input information of different classifications, the synthesis model SM1 that generates the synthesized information obtained by synthesizing the pieces of characteristic information generated by the encoders E1 and E2, and the decoders D1 and D2 that generate pieces of output information corresponding to the pieces of input information of different classifications from the synthesized information generated by the synthesis model SM1. For example, the learning unit 42 learns the processing model M1 to output the output information having related content from a plurality of pieces of input information, that is, to match topics of the pieces of output information each other.

For example, the learning unit 42 learns the processing model M1 by correcting the connection coefficient of each model included in the processing model M1 so that, when the pieces of input information such as an image and writing included in the learning data are input to the input layer included in the processing model M1, various pieces of output information output by the processing model M1 become digests of the input information such as the digest image and the digest writing. More specifically, by inputting a plurality of pieces of input information included in the distribution content to the encoder that generates the characteristic information indicating the characteristic of the input information among the models included in the processing model M1, the learning unit 42 acquires pieces of characteristic information indicating the characteristics of the pieces of input information.

The learning unit 42 learns the processing model M1 including the decoders D1 and D2 that generate pieces of output information of different classifications from the synthesized information, and output the output information of the same classification as the pieces of input information input to the different encoders E1 and E2. The learning unit 42 uses the encoders E1 and E2 that have learned the characteristics of the pieces of information of different classifications, and the decoders D1 and D2 that have learned the characteristics of the pieces of information of the same classification as the different encoders E1 and E2. That is, the learning unit 42 learns the processing model M1 including the encoder and the decoder included in a group of the encoder and the decoder that have learned the characteristics of the pieces of information of different classifications.

For example, the learning unit 42 learns the processing model M1 including a group of the first encoder E1 and the first decoder D1 that have learned the characteristic of the image, and a group of the second encoder E2 and the second decoder D2 that have learned the characteristic of the writing. More specifically, the learning unit 42 learns the processing model M1 including at least the first encoder E1 that generates the characteristic information indicating the characteristic of the image, the second encoder E2 that generates the characteristic information indicating the characteristic of the text, the synthesis model SM1 that generates the synthesized information obtained by synthesizing the pieces of characteristic information generated by the first encoder and the second encoder, the first decoder D1 that generates the output information corresponding to the image from the synthesized information, and the second decoder D2 that generates the output information corresponding to the text from the synthesized information.

The learning unit 42 learns the processing model M1 including the synthesis model SM1 that generates the synthesized information obtained by synthesizing the pieces of characteristic information generated by the respective encoders E in a synthesizing mode corresponding to an output mode of the content generated by using the output information output by the processing model M1. For example, the learning unit 42 learns the processing model M1 including the synthesis model SM1 that generates the synthesized information obtained by synthesizing the pieces of characteristic information generated by the respective encoders E in a synthesizing mode corresponding to the attribute of the user that is an output destination of the content. More specifically, for example, the learning unit 42 learns the processing model M1 including the synthesis model SM1 that generates synthesized information corresponding to the output mode of the content from combined information obtained by linearly combining the pieces of characteristic information generated by the respective encoders E.

The learning unit 42 uses the intermediate models MM1 and MM2 that have a structure corresponding to the classification of the input information and generate intermediate representation indicating the characteristic of the input information, and the encoders E1 and E2 that generate the characteristic information from the intermediate representation generated by the intermediate models MM1 and MM2. For example, the learning unit 42 learns the processing model M1 in which a convolution neural network is employed for the first intermediate model MM1 in which the classification of the input information is an image, and a recursive neural network is employed for the second intermediate model in which the classification of the input information is text.

The output information acquisition unit 43 acquires a plurality of pieces of output information corresponding to a plurality of pieces of input information included in predetermined content by using the encoders E1 and E2 that generate pieces of characteristic information indicating the characteristics of pieces of input information of different classifications from the pieces of input information, the synthesis model SM1 that generates synthesized information obtained by synthesizing the pieces of characteristic information generated by the encoders E1 and E2, and the decoders D1 and D2 that generate pieces of output information corresponding to the pieces of input information of different classifications from the synthesized information generated by the synthesis model SM1. That is, the output information acquisition unit 43 acquires the pieces of output information of different classifications by using the processing model M1 that has been learned by the learning unit 42 described above.

For example, the output information acquisition unit 43 acquires the distribution content as a generation target of the digest content from the data server 50. In such a case, the output information acquisition unit 43 extracts the image and the body included in the distribution content. The output information acquisition unit 43 inputs information indicating the image of the distribution content to the input layer of the first intermediate model MM1 included in the processing model M1, and inputs information indicating the body of the distribution content to the input layer of the second intermediate model MM2 included in the processing model M1. The output information acquisition unit 43 causes the processing model M1 to generate the digest image and the digest writing by sequentially transmitting a value output by each node included in the processing model M1 to another node connected to the former node while considering the connection coefficient.

The generation unit 44 generates corresponding content corresponding to the predetermined content from a plurality of pieces of output information. For example, in a case in which the digest image and the digest body are acquired from the image and the body included in the distribution content, the generation unit 44 generates the digest content including the digest image and the digest body.

The provision unit 45 provides the generated corresponding content to the user. For example, the provision unit 45 distributes the digest content generated by the generation unit 44 in response to a request from the terminal device 100. The provision unit 45 may provide the digest content generated by the generation unit 44 to the data server 50 to be distributed from the data server 50.

### 3. Regarding Learning of Processing Model

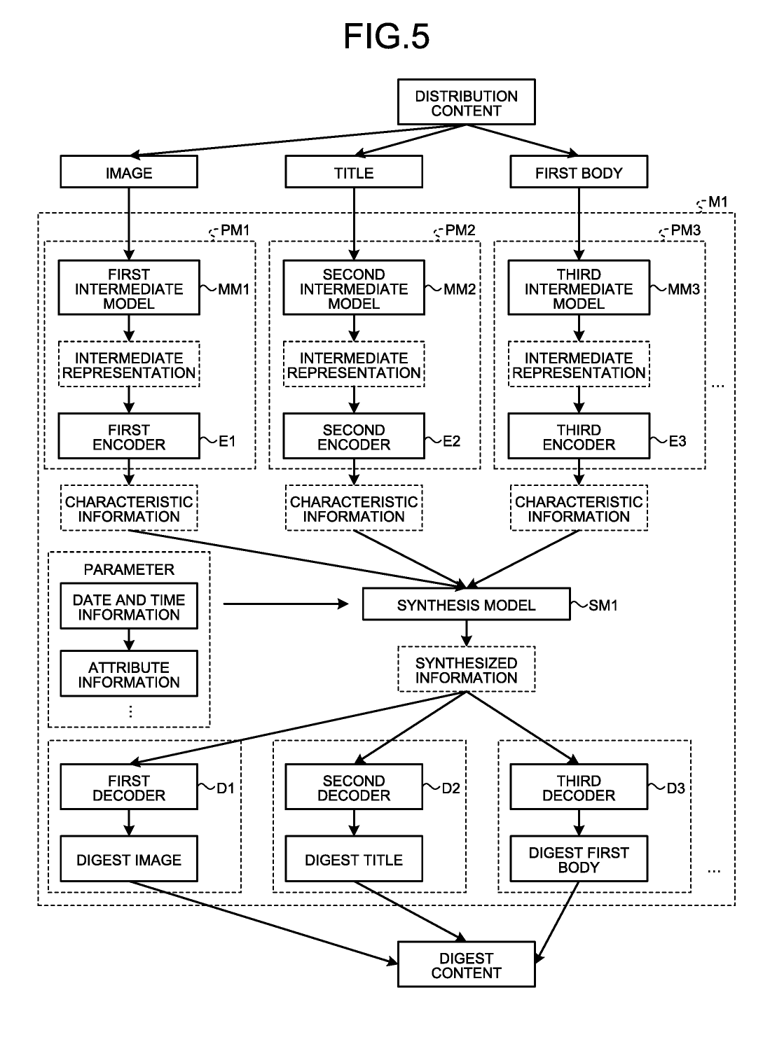

Next, the following describes an example of a processing model to be learned by the information providing device 10. FIG. 5 is a diagram illustrating an example of a structure of the processing model to be learned by the information providing device according to the embodiment. For example, in the example illustrated in FIG. 5, it is assumed that the distribution content includes various pieces of information such as an image, a title, and a first body. In such a case, the information providing device 10 generates the processing model M1 that independently generates the characteristic information for each classification of the information included in the distribution content.

For example, in the example illustrated in FIG. 5, the processing model M1 includes a partial model PM1 including the first intermediate model MM1 that generates intermediate representation from the image and the first encoder E1 that generates the characteristic information from the intermediate representation of the image. The processing model M1 also includes a partial model PM2 including the second intermediate model MM2 that generates the intermediate representation from the title, and the second encoder E2 that generates the characteristic information from the intermediate representation of the title. The processing model M1 also includes a partial model PM3 including a third intermediate model MM3 that generates the intermediate representation from the first body, and a third encoder E3 that generates the characteristic information from the intermediate representation of the first body. The processing model M1 is assumed to include a partial model for each classification of the information included in the distribution content in addition to the partial models PM1 to PM3 illustrated in FIG. 5.

The processing model M1 includes the synthesis model SM1 that generates synthesized information obtained by synthesizing the pieces of characteristic information generated by the partial models PM1 to PM3 and the like. The processing model M1 includes the first decoder D1 that generates a digest image corresponding to the image from the synthesized information, the second decoder D2 that generates a digest title corresponding to the title from the synthesized information, and a third decoder D3 that generates a digest first body corresponding to the first body from the synthesized information. That is, the processing model M1 includes a group of the encoder and the decoder for each classification of the information included in the distribution content.

By inputting various pieces of information included in the distribution content as the input information to the processing model M1 having such a configuration, the information providing device 10 acquires digests corresponding to the various pieces of information as the output information. The information providing device 10 can obtain the digest content corresponding to the input distribution content by using the acquired output information.

The information providing device 10 may vary the synthesizing mode of the synthesis model SM1 using various parameters. For example, the information providing device 10 may control the synthesizing mode used when the synthesis model SM1 generates the synthesized information from the pieces of characteristic information, based on the parameters such as date and time information indicating the date and time for generating a digest, a distribution date of distribution content, and the like, and attribute information indicating the attribute of the user that is a distribution destination. As a result of such processing, the information providing device 10 can obtain output information corresponding to the date and time of distribution and the attribute of the user.

Values of such parameters may be learned at the same time when the connection coefficient of each model is corrected at the time of learning. The parameter may be input to the input layer included in the processing model M1 as one of the pieces of input information instead of being input to the synthesis model SM1. That is, the information providing device 10 may generate the processing model M1 having a structure of additionally reflecting an optional piece of information so long as the characteristic information is independently generated for each classification of the input information, the synthesized information obtained by synthesizing the generated pieces of characteristic information is generated, and the output information is independently generated for each classification from the generated synthesized information.

### 4. Processing Flow of Information Providing Device

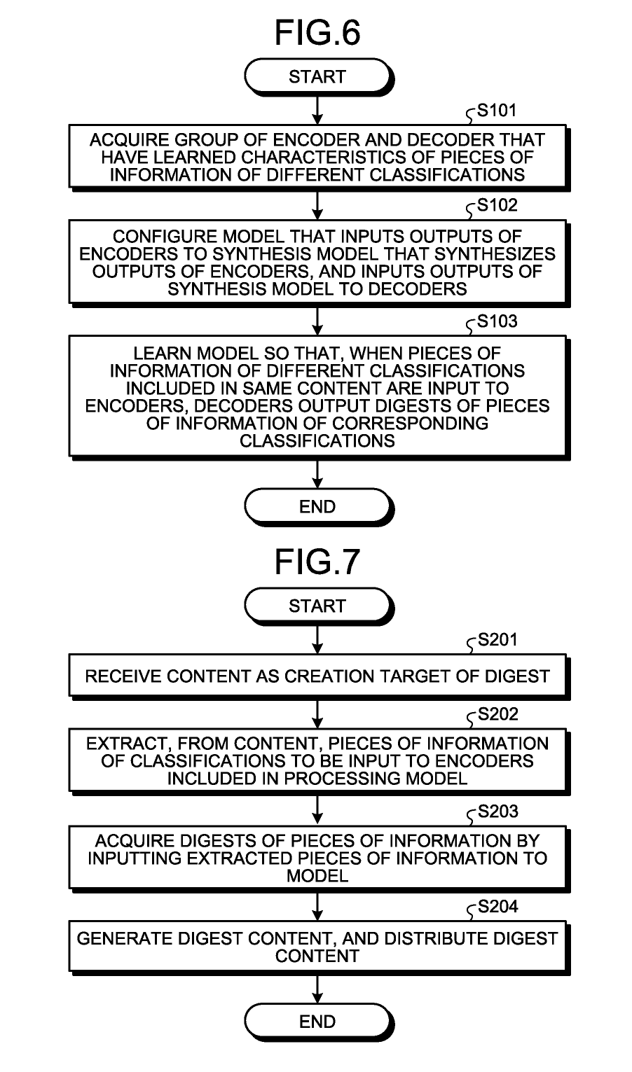

Next, the following describes an example of a procedure of learning processing and generation processing executed by the information providing device 10 with reference to FIGS. 6 and 7. FIG. 6 is a flowchart illustrating an example of a learning processing procedure executed by the information providing device according to the embodiment. FIG. 7 is a flowchart illustrating an example of a generation processing procedure executed by the information providing device according to the embodiment.

First, the following describes an example of the learning processing procedure executed by the information providing device 10 with reference to FIG. 6. First, the information providing device 10 acquires a group of the encoder and the decoder that have learned characteristics of different pieces of information (Step S101). Subsequently, the information providing device 10 configures the processing model M1 that inputs an output of each encoder E to the synthesis model SM1 that synthesizes outputs of the encoders E, and inputs an output of the synthesis model SM1, that is, the synthesized information to each decoder D (Step S102). The information providing device 10 learns the model so that, when pieces of information of different classifications included in the same content are input to the respective encoders E, each decoder D outputs a digest of information of corresponding classification (Step S103), and ends the learning processing.

Next, the following describes an example of the generation processing procedure executed by the information providing device 10 with reference to FIG. 7. First, the information providing device 10 receives content as a creation target of a digest, that is, the distribution content (Step S201). In such a case, the information providing device 10 extracts, from the distribution content, information of classification to be input to the encoders E included in the processing model M1 (Step S202). The information providing device 10 then acquires the digests of the pieces of information by inputting the extracted information to the processing model M1 (Step S203). Thereafter, the information providing device 10 generates the digest content as a digest of the distribution content using the acquired digest, distributes the generated digest content (Step S204), and ends the processing.

### 5. Modification

In the above description, described is an example of the learning processing and the generation processing executed by the information providing device 10. However, the embodiment is not limited thereto. The following describes variations of the learning processing and the generation processing executed by the information providing device 10.

### 5-1. Device Configuration

The information providing device 10 may be connected to an optional number of terminal devices 100 in a communicable manner, or may be connected to an optional number of data servers 50 in a communicable manner. The information providing device 10 may be implemented by a front end server that exchanges information with the terminal device 100, and a back end server that executes various pieces of processing. In such a case, the provision unit 45 illustrated in FIG. 2 is arranged in the front end server, and the back end server includes the learning data acquisition unit 41, the learning unit 42, the output information acquisition unit 43, and the generation unit 44 illustrated in FIG. 2.

For example, the information providing device 10 may be implemented by a learning server that includes the learning data acquisition unit 41 and the learning unit 42 illustrated in FIG. 2 and executes the learning processing, a generation server that includes the output information acquisition unit 43 and the generation unit 44 illustrated in FIG. 2 and executes the generation processing, and a provision server that includes the provision unit 45 illustrated in FIG. 2 and provides information generated by the generation server to the user, the servers cooperatively operating. The learning data database 31 and the model database 32 registered in the storage unit 30 may be managed by an external storage server.

### 5-2. Others

Among pieces of processing described in the above embodiment, all or part of pieces of processing described to be automatically performed can be manually performed, or all or part of pieces of processing described to be manually performed can be automatically performed using a known method. Additionally, a processing procedure, a specific name, information including various pieces of data and parameters described herein or illustrated in the drawings can be optionally changed unless otherwise specifically noted. For example, the various pieces of information illustrated in the drawings are not limited to the illustrated information.

The components of the devices illustrated in the drawings are merely conceptual, and it is not required that it is physically configured as illustrated necessarily. That is, specific forms of distribution and integration of the devices are not limited to those illustrated in the drawings. All or part thereof may be functionally or physically distributed/integrated in arbitrary units depending on various loads or usage states.

The embodiments described above can be appropriately combined in a range in which pieces of processing content do not contradict each other.

### 6. Program

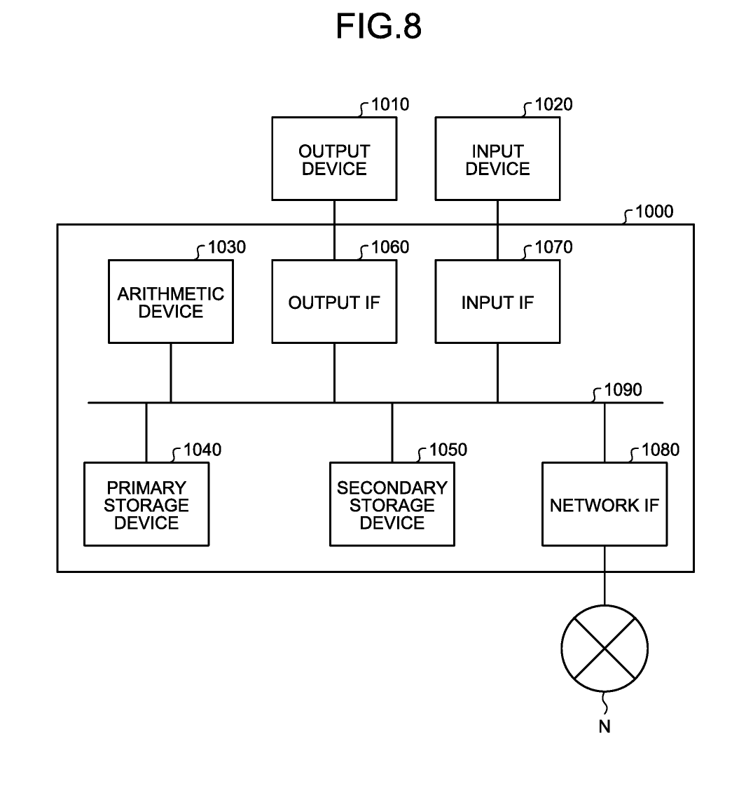

The information providing device 10 according to the embodiment described above is implemented by a computer 1000 having a configuration illustrated in FIG. 8, for example. FIG. 8 is a diagram illustrating an example of a hardware configuration. The computer 1000 is connected to an output device 1010 and an input device 1020, and has a form in which an arithmetic device 1030, a primary storage device 1040, a secondary storage device 1050, an output interface (IF) 1060, an input IF 1070, and a network IF 1080 are connected with each other via a bus 1090.

The arithmetic device 1030 operates based on a program stored in the primary storage device 1040 or the secondary storage device 1050, a program read out from the input device 1020, and the like, and executes various pieces of processing. The primary storage device 1040 is a memory device such as a RAM that temporarily stores data used by the arithmetic device 1030 for various arithmetic operations. The secondary storage device 1050 is a storage device in which data used by the arithmetic device 1030 for various arithmetic operations and various databases are registered, and implemented by a read only memory (ROM), a hard disk drive (HDD), a flash memory, and the like.

The output IF 1060 is an interface for transmitting information as an output target to the output device 1010 that outputs various pieces of information such as a monitor and a printer, and implemented by, for example, a connector conforming to a standard such as a universal serial bus (USB), a digital visual interface (DVI), and a high definition multimedia interface (HDMI) (registered trademark). The input IF 1070 is an interface for receiving information from various input devices 1020 such as a mouse, a keyboard, and a scanner, and implemented by a USB, for example.

For example, the input device 1020 may be a device that reads out information from an optical recording medium such as a compact disc (CD), a digital versatile disc (DVD), and a phase change rewritable disk (PD), a magneto-optical recording medium such as a magneto-optical disk (MO), a tape medium, a magnetic recording medium, a semiconductor memory, or the like. The input device 1020 may be an external storage medium such as a USB memory.

The network IF 1080 receives data from another appliance via the network N to be transmitted to the arithmetic device 1030, and transmits data generated by the arithmetic device 1030 to another appliance via the network N.

The arithmetic device 1030 controls the output device 1010 and the input device 1020 via the output IF 1060 and the input IF 1070. For example, the arithmetic device 1030 loads the program onto the primary storage device 1040 from the input device 1020 or the secondary storage device 1050, and executes the loaded program.

For example, in a case in which the computer 1000 functions as the information providing device 10, the arithmetic device 1030 of the computer 1000 executes data or a program loaded onto the primary storage device 1040 (for example, the processing model M1) to implement the function of the control unit 40. The arithmetic device 1030 of the computer 1000 reads the program or data (for example, the processing model M1) from the primary storage device 1040 to be executed. Alternatively, for example, the program may be acquired from another device via the network N.

### 7. Effect

As described above, the information providing device 10 acquires a group of pieces of information of different classifications as the learning data. The information providing device 10 learns the processing model M1 including a plurality of encoders E that generate pieces of characteristic information indicating characteristics of pieces of input information from the pieces of input information of different classifications so that, when the learning data is assumed to be the input information, output information corresponding to the learning data is output, the synthesis model SM1 that generates the synthesized information obtained by synthesizing the pieces of characteristic information generated by the encoders E, and a plurality of decoders D that generate pieces of output information corresponding to the pieces of input information of different classifications from the synthesized information generated by the synthesis model SM1.

The processing model M1 described above can reduce time required for learning and a calculation resource as compared with a DNN in the related art. As a result, the information providing device 10 can facilitate learning of relevance included in the learning data.

The information providing device 10 learns a plurality of decoders D that generate pieces of output information of different classifications from the synthesized information, and output pieces of output information of the same classification as the pieces of information input to different encoders E. The information providing device 10 learns a plurality of encoders E that have learned the characteristics of pieces of information of different classifications, and a plurality of decoders D that have learned characteristics of the pieces of information of the same classification as different encoders E. Thus, the information providing device 10 can learn the processing model M1 that appropriately outputs the output information corresponding to the input information.

The information providing device 10 learns at least the first encoder E1 that generates the characteristic information indicating the characteristic of the image, the second encoder E2 that generates the characteristic information indicating the characteristic of the text, the synthesizing device that generates the synthesized information obtained by synthesizing pieces of characteristic information generated by the first encoder E1 and the second encoder E2, the first decoder D1 that generates the output information corresponding to the image from the synthesized information, and the second decoder D2 that generates the output information corresponding to the text from the synthesized information. Thus, the information providing device 10 can learn the processing model M1 that appropriately outputs the output information corresponding to the image and the text.

The information providing device 10 learns the synthesis model SM1 that generates the synthesized information obtained by synthesizing the pieces of characteristic information generated by the encoders E in the synthesizing mode corresponding to the output mode of the output information. For example, the information providing device 10 learns the synthesis model SM1 that generates the synthesized information obtained by synthesizing the pieces of characteristic information generated by the encoders E in the synthesizing mode corresponding to the attribute of the user that is an output destination of corresponding content. For example, the information providing device 10 learns the synthesis model SM1 that generates the synthesized information corresponding to the output mode of the corresponding content from the combined information obtained by linearly combining the pieces of characteristic information generated by the encoders E. Thus, the information providing device 10 can learn the processing model M1 that generates output information considering the output mode of the corresponding content.

The information providing device 10 learns the intermediate models MM1 and MM2 that have a structure corresponding to the classification of the input information and generate the intermediate representation indicating the characteristic of the input information, and the encoders E that generate the characteristic information from the intermediate representation generated by the intermediate models MM1 and MM2. For example, the information providing device 10 learns a model that is a recursive neural network as the second intermediate model MM2 that generates the intermediate representation of the input information that is the text, and learns a model that is a convolution neural network as the first intermediate model MM1 that generates the intermediate representation of the input information that is the image. Thus, the information providing device 10 can learn the processing model M1 that extracts the characteristic information of the input information more appropriately.

The information providing device 10 learns the encoders E and the decoders D included in a plurality of groups of the encoder E and the decoder D that have learned the characteristics of the pieces of information of different classifications. That is, the information providing device 10 performs pre-training for each group of the encoder E and the decoder D that process pieces of information of the same classification. Thus, the information providing device 10 can easily improve accuracy of the processing model M1.

The information providing device 10 learns at least one of the encoder E, the synthesis model SM1, and the encoder E so that output information including related content is output from a plurality of pieces of input information included in predetermined content. Thus, the information providing device 10 can learn the processing model M1 that generates pieces of output information having the same topic.

The information providing device 10 acquires a plurality of pieces of output information corresponding to a plurality of pieces of input information included in predetermined content by using a plurality of encoders E that generate pieces of characteristic information indicating the characteristics of the pieces of input information from the pieces of input information of different classifications, the synthesis model SM1 that generates the synthesized information obtained by synthesizing the pieces of characteristic information generated by the encoders E, and a plurality of decoders D that generate pieces of output information corresponding to the pieces of input information of different classifications from the synthesized information generated by the synthesis model SM1. That is, the information providing device 10 acquires a plurality of pieces of output information corresponding to a plurality of pieces of input information included in the predetermined content by using the processing model M1. The information providing device 10 then generates corresponding content corresponding to the predetermined content from the acquired pieces of output information. Thus, the information providing device 10 can provide the corresponding content based on the pieces of output information having the same topic.

Some embodiments of the present invention have been described above in detail based on the drawings, but the embodiments are merely examples. The present invention can be implemented in another form that is variously modified and improved based on knowledge of those skilled in the art in addition to the aspects described in SUMMARY OF THE INVENTION.

The word “unit” described above can be read as a “module”, a “circuit”, and the like. For example, the distribution unit can be read as a distribution module or a distribution circuit.

According to an aspect of the embodiment, learning of the relevance included in the learning data can be facilitated.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A learning device comprising:
an acquisition unit that acquires a plurality of pieces of input information of different classifications; and
a learning unit that learns a model as a model that outputs, when the pieces of input information are inputted, a plurality of pieces of output information corresponding to the respective pieces of input information; wherein the model including:
a plurality of encoding parts that generate pieces of characteristic information indicating characteristics of the pieces of input information from the pieces of input information;
a synthesizing part that generates synthesized information obtained by synthesizing the pieces of characteristic information generated by the encoding parts; and
a plurality of decoding parts that generate pieces of output information of different classifications from the synthesized information generated by the synthesizing part.

2. The learning device according to claim 1, wherein the learning unit learns the decoding parts that generate pieces of output information from the synthesized information, the classifications of each pieces of output information are different and the classifications of each pieces of output information is same classification of pieces of input information input to different encoding parts.

3. The learning device according to claim 1, wherein the learning unit learns the encoding parts that have learned characteristics of pieces of information of different classifications, and the decoding parts that have learned characteristics of pieces of information of the same classification as different encoding parts.

4. The learning device according to claim 1, wherein the learning unit learns at least a first encoding part that generates characteristic information indicating a characteristic of an image, a second encoding part that generates characteristic information indicating a characteristic of text, a synthesizing part that generates synthesized information obtained by synthesizing pieces of characteristic information generated by the first encoding part and the second encoding part, a first decoding part that generates output information corresponding to the image from the synthesized information, and a second decoding part that generates output information corresponding to the text from the synthesized information.

5. The learning device according to claim 1, wherein the learning unit learns a synthesizing part that generates synthesized information obtained by synthesizing pieces of characteristic information generated by the encoding parts in a synthesizing mode corresponding to an output mode of the output information.

6. The learning device according to claim 5, wherein the learning unit learns a synthesizing part that generates synthesized information obtained by synthesizing pieces of characteristic information generated by the encoding parts in a synthesizing mode corresponding to an attribute of a user that is an output destination of the output information.

7. The learning device according to claim 5, wherein the learning unit learns a synthesizing part that generates synthesized information corresponding to an output mode of the output information from combined information obtained by linearly combining pieces of characteristic information generated by the encoding parts.

8. The learning device according to claim 1, wherein the learning unit learns a plurality of models that have a structure corresponding to a classification of input information and generate intermediate representation indicating a characteristic of input information, and learns the encoding parts that generate the characteristic information from the intermediate representation generated by each model.

9. The learning device according to claim 8, wherein the learning unit learns a model that is a recurrent neural network as a model that generates intermediate representation of input information that is text, and learns a model that is a convolution neural network as a model that generates intermediate representation of input information that is an image.

10. The learning device according to claim 1, wherein the learning unit learns a plurality of encoding parts and a plurality of decoding parts included in a plurality of groups of an encoding part and a decoding part, the each of groups have learned characteristics of pieces of information belonging to different classifications.

11. The learning device according to claim 1, wherein the learning unit learns at least one of the encoding part, the synthesizing part, and the encoding part to output pieces of output information having related content from a plurality of pieces of input information included in predetermined content.

12. A generation device comprising:
an acquisition unit that acquires a plurality of pieces of output information corresponding to a plurality of pieces of input information included in predetermined content by using a plurality of encoding parts that generate pieces of characteristic information indicating characteristics of pieces of input information from the pieces of input information of different classifications, a synthesizing part that generates synthesized information obtained by synthesizing the pieces of characteristic information generated by the encoding parts, and a plurality of decoding parts that generate pieces of output information corresponding to the pieces of input information of different classifications from the synthesized information generated by the synthesizing part; and
a generation unit that generates corresponding content corresponding to the predetermined content from the pieces of output information acquired by the acquisition unit.

13. A learning method executed by a learning device, the method comprising:
acquiring a plurality of pieces of input information of different classifications; and
learning a model as a model when the pieces of input information are inputted, outputs a plurality of pieces of output information corresponding to the respective pieces of input information; wherein the model including:
a plurality of encoding parts that generate pieces of characteristic information indicating characteristics of the pieces of input information from the pieces of input information;
a synthesizing part that generates synthesized information obtained by synthesizing the pieces of characteristic information generated by the encoding parts; and
a plurality of decoding parts that generate pieces of output information of different classifications from the synthesized information generated by the synthesizing part.

14. A generation method executed by a generation device, the method comprising:
acquiring a plurality of pieces of output information corresponding to a plurality of pieces of input information included in predetermined content by using a plurality of encoding parts that generate pieces of characteristic information indicating characteristics of pieces of input information from the pieces of input information of different classifications, a synthesizing part that generates synthesized information obtained by synthesizing the pieces of characteristic information generated by the encoding parts, and a plurality of decoding parts that generate pieces of output information corresponding to pieces of input information of different classifications from the synthesized information generated by the synthesizing part; and
generating corresponding content corresponding to the predetermined content from the acquired pieces of output information.

15. A non-transitory computer-readable storage medium having stored therein a learning program that causes a computer to execute a process comprising:
acquiring a plurality of pieces of input information of different classifications; and
learning a model as a model when the pieces of input information are inputted, outputs a plurality of pieces of output information corresponding to the respective pieces of input information; wherein the model including:
a plurality of encoding parts that generate pieces of characteristic information indicating characteristics of the pieces of input information from the pieces of input information;
a synthesizing part that generates synthesized information obtained by synthesizing the pieces of characteristic information generated by the encoding parts; and
a plurality of decoding parts that generate pieces of output information of different classifications from the synthesized information generated by the synthesizing part.

16. A non-transitory computer-readable storage medium having stored therein a generation program that causes a computer to execute a process comprising:
acquiring a plurality of pieces of output information corresponding to a plurality of pieces of input information included in predetermined content by using a plurality of encoding parts that generate pieces of characteristic information indicating characteristics of pieces of input information from the pieces of input information of different classifications, a synthesizing part that generates synthesized information obtained by synthesizing the pieces of characteristic information generated by the encoding parts, and a plurality of decoding parts that generate pieces of output information corresponding to pieces of input information of different classifications from the synthesized information generated by the synthesizing part; and
generating corresponding content corresponding to the predetermined content from the acquired pieces of output information.

17. A non-transitory computer-readable storage medium having stored therein a program that causes a computer to execute as a model comprising:
a plurality of encoding parts that generate pieces of characteristic information indicating characteristics of pieces of input information from the pieces of input information of different classifications;
a synthesizing part that generates synthesized information obtained by synthesizing the pieces of characteristic information generated by the encoding parts; and
a plurality of decoding parts that generate pieces of output information corresponding to pieces of input information of different classifications from the synthesized information generated by the synthesizing part.
